(19) United States
(12) Patent Application Publication
(10) Pub. No.: US 2026/0291858 A1
(43) Pub. Date: Sep. 24, 2026

(54) Lossy compression of forwarding tables

(71) Applicant: Mellanox Technologies, Ltd., Yokneam (IL)

(72) Inventors: Gil Shabat, Hod Hasharon (IL); Hanan Shteingart, Herzliya (IL); Chen Avin, Beer Sheva (IL); Yotam Harchol Thishler, Zurich (CH); Ilya Vershkov, Rishon Le Zion (IL); Barak Hermesh, Pardes Hana (IL); Alex Shpiner, Ramat Yishay (IL); Evgeny Tantsura, Emerald Hills, CA (US); Roey Yadgar, Raanana (IL); Eitan Zahavi, Zichron Yaakov (IL)

(21) Appl. No.: 19/390,572

(22) Filed: Nov. 16, 2025

Related U.S. Application Data
(60) Provisional application No. 63/776,303, filed on Mar. 24, 2025.

(51) Int. Cl. H04L 45/24; H04L 45/122; H04L 45/745

(52) U.S. Cl. CPC H04L 45/24; H04L 45/122; H04L 45/745

(57) ABSTRACT

In one embodiment, a network switch includes a memory to store an input routing table including input routes and associated logical port groups, such that each input route is associated with a logical port group, and processing circuitry to generate a hardware multi-path routing table having a capacity smaller than the input routing table, cluster the input routes into group clusters based on similarities between the associated logical port groups, compress the logical port groups into a subset of compressed logical port groups by modifying port indicators, the subset of compressed logical port groups corresponding to the group clusters, add entries in the hardware multi-path routing table corresponding to the subset of compressed logical port groups, and map the input routes to the entries in the hardware multi-path routing table.

### RELATED APPLICATION INFORMATION

The present application claims benefit of US Provisional Patent Application Ser. No. 63/776,303 of Shabat, et al., filed 24 Mar. 2025, the disclosure of which is hereby incorporated herein by reference.

### FIELD OF THE DISCLOSURE

The present disclosure relates to network switches, and more particularly but not exclusively to routing tables.

### BACKGROUND

Network switches play a central role in modern data center architectures, facilitating the routing of data packets between various network devices. As data centers continue to grow in size and complexity, the demands placed on network switches have increased substantially. One of the primary functions of a network switch is to maintain and utilize routing tables, which contain information about how to forward packets to their intended destinations.

Routing tables typically consist of entries mapping destination addresses to output ports or next-hop information. In traditional implementations, these tables are stored in the switch's memory and consulted for each incoming packet to determine the appropriate forwarding action. However, as networks expand and the number of possible destinations increases, the size of routing tables can grow considerably.

Modern network switches often employ hardware-based forwarding engines to achieve high-speed packet processing. These hardware implementations have limitations on the amount of memory available for storing routing information. This constraint creates challenges when dealing with large-scale networks that require extensive routing tables.

### OVERVIEW

There is provided in accordance with an embodiment of the present disclosure, a network switch, comprising a memory to store an input routing table including input routes and associated logical port groups, such that each input route is associated with a logical port group, and processing circuitry to generate a hardware multi-path routing table having a capacity smaller than the input routing table, cluster the input routes into group clusters based on similarities between the associated logical port groups, compress the logical port groups into a subset of compressed logical port groups by modifying port indicators, the subset of compressed logical port groups corresponding to the group clusters, add entries in the hardware multi-path routing table corresponding to the subset of compressed logical port groups, and map the input routes to the entries in the hardware multi-path routing table.

Further in accordance with an embodiment of the present disclosure, the processing circuitry is to generate an internal data structure to aggregate and organize routing information from the input routing table, wherein the internal data structure includes unique port groups and maintains count information for each unique port group.

Still further in accordance with an embodiment of the present disclosure, the processing circuitry is to cluster the input routes by selecting a new input route, analyzing options to add the new input route to an existing group cluster or to merge two existing group clusters to create space in the hardware multi-path routing table for a new group cluster, which includes the new input route, and selecting one of the options that results in a lower cost based on a defined cost function.

Additionally, in accordance with an embodiment of the present disclosure, the cost function accounts for a Hamming distance between original and compressed logical port groups, and a count of the routes mapped to each logical port group.

Moreover, in accordance with an embodiment of the present disclosure, the cost function accounts for weights associated with the routes, and priorities of the routes.

Further in accordance with an embodiment of the present disclosure, the processing circuitry is to configure a parameter to balance between optimizing a total cost across the routes and optimizing a maximum cost for any single one of the routes.

Still further in accordance with an embodiment of the present disclosure, the processing circuitry is to intermittently attempt to improve the clustering by selecting one of the logical port groups, and attempting to move the selected logical port group to a different one of the group clusters to reduce a cost across the routes.

Additionally, in accordance with an embodiment of the present disclosure, the processing circuitry is to compress the logical port groups by changing one or more port indicators from active to inactive to allow multiple original logical port groups to be represented by a single compressed logical port group in the hardware multi-path routing table.

Moreover, in accordance with an embodiment of the present disclosure, the single compressed logical port group maintains connectivity for original logical port groups mapped to the single compressed logical port group by preserving active port indicators that are common across the original logical port groups.

Further in accordance with an embodiment of the present disclosure, the network switch further comprises a plurality of network ports to receive and transmit data packets, and a packet forwarding engine to forward the received data packets based on the hardware multi-path routing table.

Still further in accordance with an embodiment of the present disclosure, the packet forwarding engine is to extract a destination address from a received data packet, look up the destination address in the hardware multi-path routing table to determine an egress port, and forward the data packet through the determined egress port.

There is provided in accordance with another embodiment of the present disclosure, a method for compressing a routing table in a network switch, comprising receiving an input routing table including input routes and associated logical port groups, such that each input route is associated with a logical port group, generating a hardware multi-path routing table having a capacity smaller than the input routing table, clustering the input routes into group clusters based on similarities between the associated logical port groups, compressing the logical port groups into a subset of compressed logical port groups by modifying port indicators, the subset of compressed logical port groups corresponding to the group clusters, adding entries in the hardware multi-path routing table corresponding to the subset of compressed logical port groups, and mapping the input routes to the entries in the hardware multi-path routing table.

Additionally, in accordance with an embodiment of the present disclosure, the method further comprises generating an internal data structure to aggregate and organize routing information from the input routing table, wherein the internal data structure includes unique port groups and maintains count information for each unique port group.

Moreover, in accordance with an embodiment of the present disclosure, clustering the input routes comprises selecting a new input route, analyzing options to add the new input route to an existing group cluster or to merge two existing group clusters to create space in the hardware multi-path routing table for a new group cluster, which includes the new input route, and selecting one of the options that results in a lower cost based on a defined cost function.

Further in accordance with an embodiment of the present disclosure, the cost function accounts for a Hamming distance between original and compressed logical port groups, and a count of the routes mapped to each logical port group.

Still further in accordance with an embodiment of the present disclosure, the cost function accounts for weights associated with the routes, and priorities of the routes.

Additionally, in accordance with an embodiment of the present disclosure, the method further comprises configuring a parameter to balance between optimizing a total cost across the routes and optimizing a maximum cost for any single one of the routes.

Moreover, in accordance with an embodiment of the present disclosure, the method further comprises intermittently attempting to improve the clustering by selecting one of the logical port groups, and attempting to move the selected logical port group to a different one of the group clusters to reduce a cost across the routes.

Further in accordance with an embodiment of the present disclosure, compressing the logical port groups comprises changing one or more port indicators from active to inactive to allow multiple original logical port groups to be represented by a single compressed logical port group in the hardware multi-path routing table.

Still further in accordance with an embodiment of the present disclosure, the single compressed logical port group maintains connectivity for original logical port groups mapped to the single compressed logical port group by preserving active port indicators that are common across the original logical port groups.

### BRIEF DESCRIPTION OF THE DRAWINGS

The present disclosure will be understood from the following detailed description, taken in conjunction with the drawings in which:

FIG. 1 is a simplified pictorial illustration of a network having a leaf-spine architecture, constructed and operative in accordance with an embodiment of the present disclosure;

FIG. 2 is a view example routing tables in the network of FIG. 1;

FIG. 3 is a view of data structures used to generate a hardware multi-path routing table for use in the network of FIG. 1;

FIG. 4 is a simplified pictorial illustration of a clustering arrangement for compressing routing table entries, in accordance with an embodiment of the present disclosure;

FIG. 5 is a simplified pictorial illustration of a system for adding entries to group clusters in a hardware multi-path routing table, according to an aspect of the present disclosure;

FIG. 6 is a simplified pictorial illustration of a system for merging clusters and adding a new cluster in a hardware multi-path routing system, in accordance with an embodiment of the present disclosure;

FIG. 7 is a simplified pictorial illustration of the effect of moving a group to a different cluster to reduce overall cost for routes, according to an aspect of the present disclosure;

FIG. 8 is a flowchart including steps in a method of generating a compressed hardware multi-path routing table in the network of FIG. 1; and

FIG. 9 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

### Overview of Example Embodiments

Network switches in modern data centers face significant challenges in managing routing tables as networks grow in size and complexity. Traditional routing tables contain entries mapping destination addresses to output ports, but the number of entries can become prohibitively large for hardware-based forwarding engines with limited memory. This creates a need for efficient compression and organization of routing information to improve memory utilization, maintain fast lookup times, and handle larger network topologies.

Embodiments of the present disclosure address at least some of the above drawbacks by providing a system and method for lossy compression of routing tables in network switches. The system uses a clustering-based approach to compress multiple input routes into a smaller set of hardware multi-path routing (HW MPR) groups while minimizing the impact on routing performance. Examples of MPR include adaptive routing and equal-cost multi-path routing (ECMP).

In some embodiments, the system receives an input routing table containing IP prefixes and corresponding logical port groups. It then generates a hardware multi-path routing (MPR) table with a smaller capacity than the input table. The system clusters input routes based on similarities between their associated logical port groups and compresses them into a subset of compressed logical port groups by modifying port indicators. These compressed groups are added as entries in the hardware multi-path routing table, and input routes are mapped to these entries.

In some cases, the system employs a cost function to guide the compression process. This function accounts for factors such as the Hamming distance between original and compressed port groups, the number of routes mapped to each group, route weights, and priorities. A configurable parameter allows balancing between optimizing total cost across routes and optimizing the maximum cost for any single route.

The system can handle dynamic updates efficiently by analyzing options to add new routes to existing clusters or merge clusters to create space for new entries. It also intermittently attempts to improve clustering by moving groups between clusters to reduce overall cost.

### Definitions

As used herein, the term “network switch” may refer to a networking device that connects devices within a computer network by using packet switching to receive, process, and forward data to the destination device. In some cases, a network switch may operate at the data link layer (Layer 2) or the network layer (Layer 3) of the Open Systems Interconnection (OSI) model.

As used herein, the term “routing table” may refer to a data structure stored in a network device that contains information about the topology of the network. In some cases, the routing table may include a set of input routes, where each input route specifies a destination, associated forwarding information (including corresponding egress ports).

As used herein, the term “hardware multi-path routing table” (HW MPR table) may refer to a table with limited capacity, where each entry is a hardware multi-path routing (HW MPR) group. In some cases, the hardware multi-path routing table may contain a subset of the entries from the full routing table, with multiple original entries potentially mapped to a single compressed entry.

As used herein, the term “logical port group” may refer to a full set of next-hop ports to reach an IP prefix. In some cases, a logical port group may be represented as a binary pattern indicating which ports are active or inactive for a particular route.

As used herein, the term “input route” may refer to a tuple consisting of an IP prefix and a corresponding logical port group. In some cases, an input route specifies a destination and the associated forwarding information.

As used herein, the term “port” may refer to a single port on a switch that allows for the connection of network cable(s) to enable data transmission between devices.

As used herein, the term “hardware multi-path routing group” (HW MPR group) may refer to a set of ports stored on the hardware multi-path routing table. In some cases, a HW MPR group represents a compressed version of one or more logical port groups.

As used herein, the term “multi-path routing group mapping” (MPR group mapping) may refer to a mapping function that maps an IP prefix to a hardware multi-path routing group index. In some cases, this mapping function enables the network switch to determine which entry in the hardware multi-path routing table should be used for forwarding packets to a specific destination.

As used herein, the term “memory” may refer to a storage component in a network switch that holds data and instructions for processing circuitry. For example, memory may store routing tables and forwarding information used by the switch.

As used herein, the term “processing circuitry” may refer to computational hardware components that execute instructions and perform data processing operations in a network device. For example, processing circuitry may include CPUs, ASICs, or other processors that implement routing algorithms and manage network operations.

As used herein, the term “network ports” may refer to physical or logical interfaces on a network switch that enable data transmission between devices. For example, network ports may include physical interfaces such as Ethernet ports or fiber optic interfaces that connect to network cables and other network devices, or logical interfaces such as loopback ports that do not require physical cable connections.

As used herein, the term “packet forwarding engine” may refer to a hardware and/or software component that processes incoming data packets and determines their appropriate output destinations. For example, a packet forwarding engine may examine packet headers and consult routing tables to direct packets to the correct egress ports.

As used herein, the term “input routing table” may refer to a data structure containing routing information including destination prefixes and their associated forwarding instructions. For example, an input routing table may include IP prefixes mapped to logical port groups indicating which ports can be used to reach specific destinations.

As used herein, the term “compressed logical port groups” may refer to reduced representations of original port group information that combine multiple port groups into fewer entries while preserving at least some connectivity. For example, compressed logical port groups may use bitwise operations to merge similar port patterns into single entries.

As used herein, the term “internal data structure” may refer to an intermediate organizational framework used to aggregate and process routing information before compression. For example, an internal data structure may maintain unique port groups with associated count and priority information.

As used herein, the term “entries” may refer to individual records or items stored within a data structure or table. For example, entries in a hardware routing table may represent compressed port groups that correspond to multiple original routes.

As used herein, the term “destination address” may refer to the target network location specified in a data packet header that indicates where the packet should be delivered. For example, a destination address may be an IP address that the forwarding engine uses to determine the appropriate output port.

As used herein, the term “port indicators” may refer to binary or logical markers that specify whether individual ports are active or inactive for a particular route. For example, port indicators may be represented as bits in a binary pattern where ‘1’ indicates an active port and ‘0’ indicates an inactive port.

As used herein, the term “egress port” may refer to the output interface through which a data packet exits a network switch toward its destination. For example, an egress port may be selected based on routing table lookups and load balancing algorithms.

As used herein, the term “data packets” may refer to formatted units of information transmitted across a network that contain both payload data and control information. For example, data packets may include IP packets with headers specifying source and destination addresses.

As used herein, the term “group clusters” may refer to collections of similar logical port groups that have been organized together based on common characteristics for compression purposes. For example, group clusters may contain port groups with similar activation patterns that can be represented by a single compressed entry.

As used herein, the term “similarities” may refer to common characteristics or patterns shared between logical port groups that make them suitable for clustering together. For example, similarities may include overlapping active ports or comparable connectivity patterns.

As used herein, the term “unique port groups” may refer to distinct port group patterns that appear in the routing table without duplication. For example, unique port groups may be identified by comparing binary patterns and eliminating redundant entries.

As used herein, the term “count information” may refer to numerical data indicating how many times a particular port group appears or is referenced in the routing table. For example, count information may track the frequency of each unique port group to inform compression decisions.

As used herein, the term “generate” may refer to the process of creating or producing a new data structure or table from existing information. For example, processing circuitry may generate a hardware routing table by compressing information from an input routing table.

As used herein, the term “cluster” or “clustering” may refer to the process of grouping similar items together based on shared characteristics or patterns. For example, clustering may involve organizing logical port groups with similar activation patterns into the same group, or grouping similar input routes together based on similarities in their associated logical port groups. In some cases, clustering may be used to reduce the number of unique entries that need to be stored in a hardware multi-path routing table.

As used herein, the term “compress” may refer to the process of reducing the size or number of entries in a data structure while preserving essential information. For example, compressing may involve combining multiple logical port groups into fewer compressed entries.

As used herein, the term “add” may refer to the process of inserting new entries or information into a data structure or table. For example, adding may involve placing compressed logical port groups as entries in a hardware routing table.

As used herein, the term “map” may refer to the process of establishing relationships or connections between elements in different data structures. For example, mapping may involve linking input routes to corresponding entries in a hardware routing table.

As used herein, the term “store” may refer to the process of saving or retaining data in a memory or storage device for later retrieval and use. For example, storing may involve placing routing table information in switch memory.

As used herein, the term “receive” may refer to the process of accepting or obtaining data, packets, or information from an external source. For example, network ports may receive incoming data packets from connected network devices.

As used herein, the term “transmit” may refer to the process of sending or forwarding data, packets, or information to an external destination. For example, network ports may transmit outgoing data packets to connected network devices.

As used herein, the term “forward” may refer to the process of directing data packets from input ports to appropriate output ports based on routing decisions. For example, a forwarding engine may forward packets through determined egress ports.

As used herein, the term “extract” may refer to the process of retrieving or obtaining specific information from a larger data structure or packet. For example, extracting may involve obtaining destination addresses from packet headers.

As used herein, the term “look up” may refer to the process of searching for and retrieving information from a table or database using a key or identifier. For example, looking up may involve finding routing information using a destination address as the search key.

As used herein, the term “aggregate” may refer to the process of combining or collecting multiple pieces of information into a unified structure. For example, aggregating may involve gathering routing information from multiple sources into an internal data structure.

As used herein, the term “organize” may refer to the process of arranging or structuring information in a systematic and logical manner. For example, organizing may involve arranging port groups and their associated metadata in an internal data structure.

As used herein, the term “maintain” may refer to the process of keeping, preserving, or updating information over time. For example, maintaining may involve keeping count information current as routing table entries change.

As used herein, the term “cost function” may refer to a mathematical formula or algorithm used to evaluate and compare different clustering or compression options. For example, a cost function may consider factors like Hamming distance between two port groups, represented as binary strings, or a comparison of such Hamming distance from each port group to a compressed port group, such as the bitwise AND of multiple port groups, and route counts to determine optimal groupings.

As used herein, the term “Hamming distance” may refer to a metric that measures the number of differing positions between binary strings. For example, Hamming distance may quantify how many port indicators differ between two port groups represented as binary strings.

As used herein, the term “weights” may refer to numerical values assigned to routes or entries to indicate their relative importance or priority in processing decisions. For example, weights may be used to prioritize certain routes based on expected traffic volume or importance.

As used herein, the term “priorities” may refer to ranking or precedence values assigned to routes or entries to determine their order of processing or importance. For example, priorities may distinguish between high-priority and low-priority routes in compression decisions.

As used herein, the term “options” may refer to alternative choices or possibilities available when making decisions about clustering or compression operations. For example, options may include adding a new route to an existing cluster or merging clusters to create space.

As used herein, the term “analyzing” may refer to the process of examining and evaluating different possibilities or data to make informed decisions. For example, analyzing may involve comparing the costs of different clustering options.

As used herein, the term “selecting” may refer to the process of choosing one option from multiple available alternatives based on specific criteria. For example, selecting may involve choosing the clustering option that results in the lowest cost.

As used herein, the term “attempting” may refer to the process of trying to perform an operation or achieve a goal, which may or may not succeed. For example, attempting may involve trying to move a logical port group to a different cluster to reduce overall cost.

As used herein, the term “moving” may refer to the process of transferring or relocating an item from one location or group to another. For example, moving may involve transferring a logical port group from one cluster to a different cluster.

As used herein, the term “modifying” may refer to the process of changing or altering existing data or structures to achieve a desired result. For example, modifying may involve changing port indicators to enable compression of logical port groups.

As used herein, the term “changing” may refer to the process of altering the state, value, or configuration of data or system components. For example, changing may involve switching port indicators from active to inactive states.

As used herein, the term “preserving” may refer to the process of maintaining or keeping certain characteristics or information intact during operations. For example, preserving may involve maintaining connectivity by keeping common active port indicators during compression.

As used herein, the term “capacity” may refer to the maximum amount of data, entries, or information that a storage structure or system can hold. For example, capacity may describe the limited number of entries that can be stored in a hardware routing table.

As used herein, the term “smaller” may refer to a reduced size, quantity, or capacity compared to another reference point. For example, a hardware routing table may have smaller capacity than the original input routing table.

As used herein, the term “subset” may refer to a portion or selection of items from a larger collection. For example, compressed logical port groups may represent a subset of the original port groups.

As used herein, the term “multiple” may refer to more than one item, entry, or instance of something. For example, multiple original logical port groups may be represented by a single compressed entry.

As used herein, the term “single” may refer to one individual item, entry, or instance as opposed to multiple instances. For example, a single compressed logical port group may represent several original port groups.

As used herein, the term “active” may refer to a state where a port, connection, or component is enabled and available for use in forwarding operations. For example, active ports may be indicated by ‘l’ bits in a logical port group pattern.

As used herein, the term “inactive” may refer to a state where a port, connection, or component is disabled or unavailable for use in forwarding operations. For example, inactive ports may be indicated by ‘0’ bits in a logical port group pattern.

As used herein, the term “connectivity” may refer to the ability to establish and maintain communication paths between network devices or destinations. For example, connectivity may be preserved by maintaining common active ports during compression.

As used herein, the term “common” may refer to characteristics, features, or elements that are shared among multiple items or groups. For example, common active ports may be those that are enabled across multiple original logical port groups.

As used herein, the term “new” may refer to recently created, added, or introduced items, entries, or components. For example, a new input route may be one that has just been received and needs to be processed for clustering.

As used herein, the term “existing” may refer to items, entries, or components that are already present or established in the system. For example, existing group clusters may be those that have already been formed and are available for new route additions.

As used herein, the term “original” may refer to the initial, unmodified, or source version of data or components before processing or compression. For example, original logical port groups may be the uncompressed port patterns from the input routing table.

As used herein, the term “intermittently” may refer to actions or processes that occur at regular or irregular intervals. For example, clustering improvement operations may be performed periodically to optimize routing table compression.

### System Description

Documents incorporated by reference herein are to be considered an integral part of the application except that, to the extent that any terms are defined in these incorporated documents in a manner that conflicts with definitions made explicitly or implicitly in the present specification, only the definitions in the present specification should be considered.

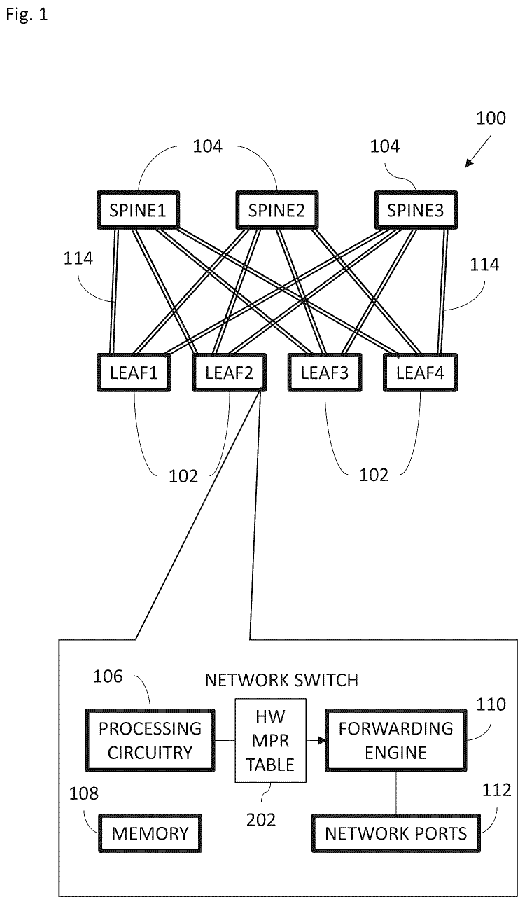

Reference is now made to FIG. 1, which is an illustration of a network topology 100 having a leaf-spine architecture. The network topology 100 may include multiple leaf nodes 102 and spine nodes 104 arranged in an interconnected configuration. In some cases, the spine nodes 104 may be positioned in an upper layer of the network topology 100 while the leaf nodes 102 may be positioned in a lower layer. Each leaf node 102 may connect to multiple spine nodes 104 through communication links 114 (only some labeled for the sake of simplicity), forming a mesh of connections between the layers.

The spine nodes 104 may provide multiple parallel paths between any pair of leaf nodes 102, enabling data to be forwarded through different available routes. In some cases, data packets may be transmitted from a source leaf node 102 to a destination leaf node 102 through one or more spine nodes 104. The communication links between the leaf nodes 102 and spine nodes 104 may dynamically change states, such as becoming active or inactive, which may affect the available forwarding paths through the network topology 100.

In some implementations, the network topology 100 may be utilized in data center environments where high-bandwidth, low-latency communication between servers or other network devices is desired. The leaf-spine architecture of the network topology 100 may provide scalability and redundancy, allowing for efficient data transmission across the network.

In some implementations, at least some nodes in the network topology 100 may be network switches. Each network switch may include processing circuitry 106, memory 108, a forwarding engine 110, and network ports 112. The processing circuitry 106 may connect to the memory 108, which may store routing and forwarding information, and other data used by processing circuitry 106. The forwarding engine 110 may interface with the processing circuitry 106 and network ports 112 to handle packet forwarding operations. The network ports 112 are configured to receive and transmit data packets. The network ports 112 may allow the switch to interface with multiple network devices and handle incoming and outgoing traffic.

The processing circuitry 106 may generate a hardware multi-path routing table 202 for use by forwarding engine 110. The hardware multi-path routing table 202 may store compressed routing information that may be used by the forwarding engine 110 to determine appropriate output ports for received packets and forward received data packets based on the compressed hardware multi-path routing table 202. The packet forwarding engine 110 may extract a destination address from a received data packet, look up the destination address in the hardware multi-path routing table 202 to determine an egress port, and forward the data packet through the determined egress port.

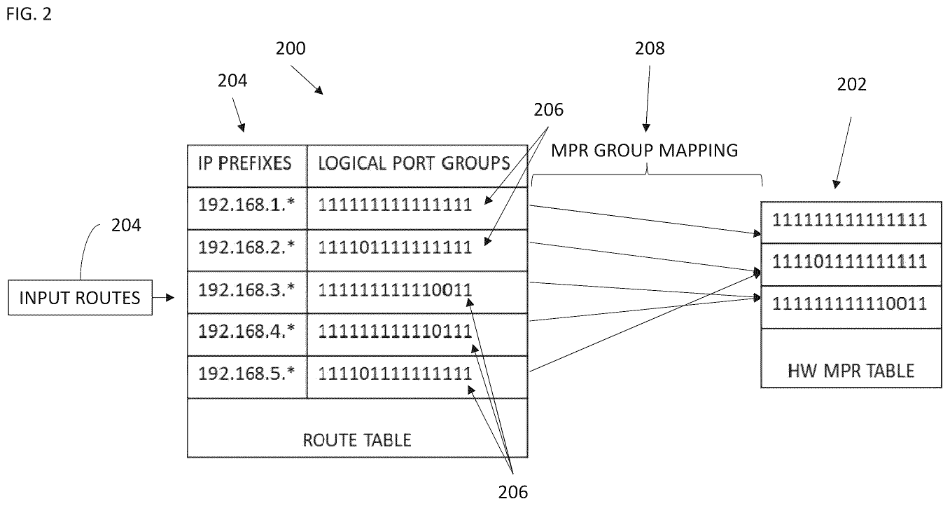

Reference is now made to FIG. 2, which is a system diagram showing a routing table arrangement. A routing table 200 may include input routes 204 (e.g., having respective IP prefixes) and associated logical port groups 206. In some cases, each input route 204 in the routing table 200 may be associated with a logical port group 206. The routing table 200 may contain routing information with corresponding logical port groups 206 represented as binary patterns indicating which ports are active.

In FIG. 2, routing table 200 may include an example IP prefix and corresponding logical port group as follows: IP Prefix: 192.168.2.*, Logical Port Group: 111101111111111. In this example, the logical port group 206 is represented as a binary pattern where each bit position corresponds to a specific port on the network switch. A ‘1’ indicates an active port for forwarding packets matching the IP prefix, while a ‘0’ indicates an inactive port. For the above example, the ports are active except for port 5. When a packet arrives with a destination IP address matching the prefix 192.168.2.*, the network switch may forward the packet to any of the active ports based on its forwarding algorithm (e.g., to any of the ports except port 5). The switch may choose a specific active port based on factors such as load balancing, network congestion, or predefined routing policies.

This binary representation allows the routing table 200 to efficiently encode which ports are available for forwarding packets to specific network destinations, enabling the switch 102, 104 to make quick forwarding decisions based on the destination IP address of incoming packets.

The memory 108 of the network switch 102, 104 may store the routing table 200. Hardware multi-path routing table 202 may be generated with a capacity smaller than the routing table 200. The hardware multi-path routing table 202 may store a compressed version of the routing information with a reduced number of entries compared to the routing table 200.

In some cases, the hardware multi-path routing table 202 may map multiple input routes from the routing table 200 to shared logical port group entries through a mapping function. This mapping may allow the hardware multi-path routing table 202 to represent the routing information in a more compact form while maintaining the essential forwarding information. An example mapping is shown in FIG. 2 by multi-path routing group mapping 208.

In some cases, the hardware multi-path routing table 202 may combine multiple entries from the routing table 200 into a single compressed entry. For example, consider two entries from the routing table 200:
1. IP Prefix: 192.168.3., Logical Port Group: 111111111110011.
2. IP Prefix: 192.168.4., Logical Port Group: 111111111110111.

These two entries may be combined into a single compressed entry in the hardware multi-path routing table 202 as follows: Logical Port Group: 111111111110011.

In this example, the logical port group 206 is compressed by using a bitwise AND operation on the original port groups. The resulting compressed entry maintains connectivity for both original prefixes while using a single entry in the hardware multi-path routing table 202. This compression may allow the hardware multi-path routing table 202 to represent more routing information within its limited capacity.

The network switch may then use this compressed entry to make forwarding decisions for packets matching either of the original IP prefixes. When a packet arrives with a destination IP address starting with 192.168.3., or 192.168.4., the switch may forward the packet to any of the active ports indicated by the compressed logical port group, potentially sacrificing some port options but maintaining essential connectivity.

The routing table 200 and hardware multi-path routing table 202 may work together to enable packet forwarding while accommodating hardware memory constraints. By compressing the routing information into the hardware multi-path routing table 202, the network switch may efficiently utilize limited memory resources while preserving routing functionality.

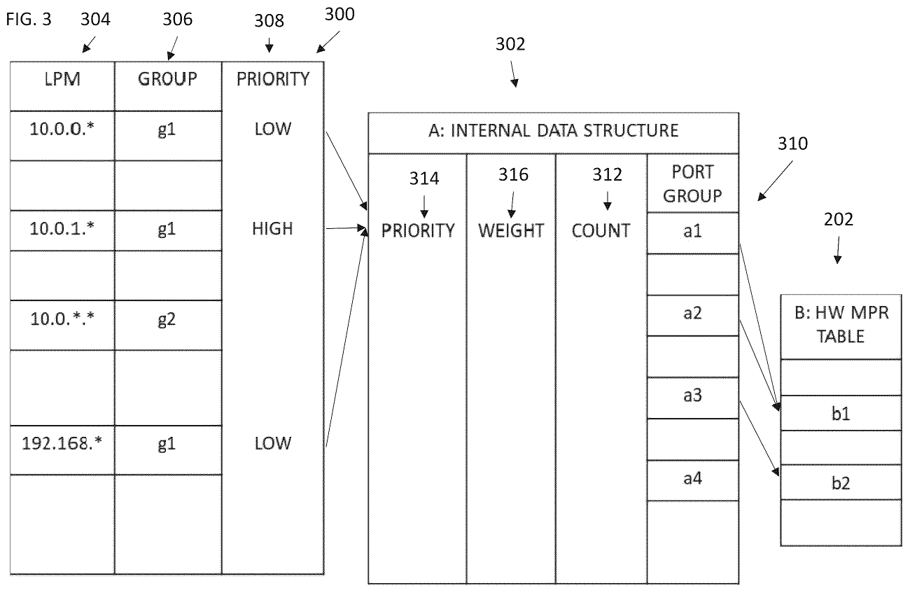

Reference is now made to FIG. 3, which is a view of data structures used to generate hardware multi-path routing table 202 for use in the network of FIG. 1.

The system includes an input routing table 300, which contains routing information including IP prefixes 304 with longest prefix matches (LPMs) and their corresponding logical port groups 306 and priority information 308. In some cases, different LPMs may share the same port group. The input routing table 300 may be stored in a memory of the network switch.

The system also includes an internal data structure 302, which is generated to aggregate and organize routing information from the input routing table 300. The internal data structure 302 contains data 310 for unique port groups (i.e., which ports are enabled and disabled for each unique port group) and maintains count 312 information for each group. FIG. 3 shows example port groups a1, a2, a3, and a4. In some cases, the internal data structure 302 may also maintain priority 314 and weight 316 information for each unique port group.

Hardware multi-path routing table 202 is generated based on the data of the internal data structure 302 and stores a compressed version of the routing information, with each entry representing a hardware multi-path routing group. FIG. 3 shows compressed routing information of groups b1 and b2. The hardware multi-path routing table 202 has a limited capacity and stores only a subset of the routing groups present in the input routing table 300. FIG. 3 shows that groups a1 and a2 have been compressed into group b1.

The data flow between these components may occur as follows:
1. Routing information from the input routing table 300 is processed into the internal data structure 302. This step involves aggregating and organizing the routing information, including identifying unique port groups and maintaining count and priority information for each group.
2. The internal data structure 302 facilitates the compression process by organizing and tracking the routing groups before they are stored in the hardware multi-path routing table 202.
3. A compression algorithm may be applied to the data in the internal data structure 302 to generate compressed routing information suitable for storage in the hardware multi-path routing table 202.
4. The compressed routing information is then stored in the hardware multi-path routing table 202, which has a smaller capacity than the input routing table 300.

In some cases, the network switch may intermittently update the internal data structure 302 and hardware multi-path routing table 202 based on changes in the input routing table 300. This process may involve adding new routes, removing obsolete routes, or modifying existing routes (e.g., based on ports changing status from enabled to disabled, and vice-versa).

The use of the internal data structure 302 as an intermediate step between the input routing table 300 and the hardware multi-path routing table 202 may allow for more efficient compression and organization of routing information. By maintaining count and priority information for each unique port group, the internal data structure 302 may provide valuable data for optimizing the compression process and ensuring that high-priority routes are adequately represented in the hardware multi-path routing table 202.

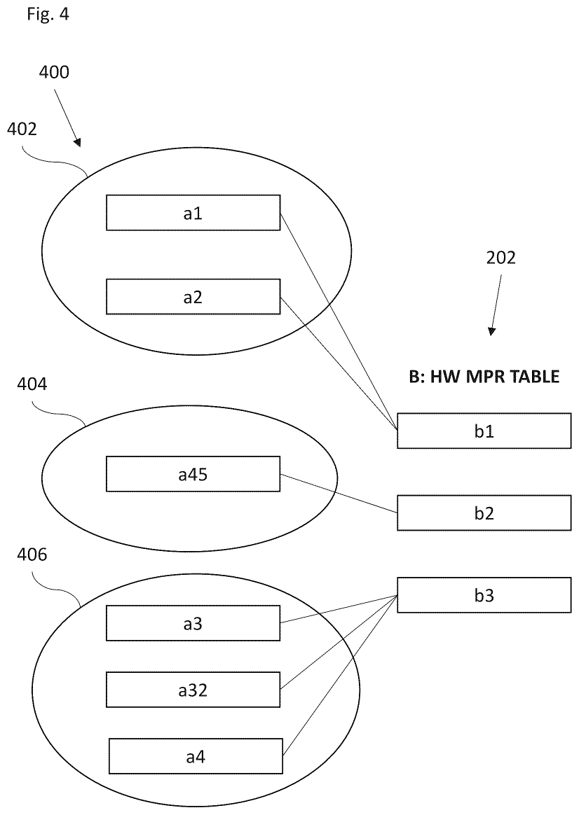

Reference is now made to FIG. 4, which is an illustration of a clustering arrangement for compressing routing table entries. The clustering arrangement includes group clusters 400. The group clusters 400 may contain multiple logical port groups that have been combined. The group clusters 400 may be organized into separate clusters, for example a group cluster 402 with groups a1 and a2, a group cluster 404 with group a45, and a group cluster 406 with groups a3, a32, and a4.

Each of the group clusters 402, 404, and 406 may represent a set of logical port groups that have been combined through a compression process. The group clusters 400 may map to entries in hardware multi-path routing table 202. For example, the group cluster 402 may map to a first entry (group b1) in the hardware multi-path routing table 202, the group cluster 404 may map to a second entry (group b2), and the group cluster 406 may map to a third entry (group b3).

The logical port groups within each of the group clusters 402, 404, and 406 may share common port activation patterns. These shared patterns may allow multiple logical port groups to be represented by a single compressed entry in the hardware multi-path routing table 202.

In some cases, input routes may be clustered into the group clusters 400 based on similarities between their associated logical port groups. The clustering process may analyze the port activation patterns of different logical port groups and group together those with similar patterns.

To compress the logical port groups into a subset of compressed logical port groups, port indicators may be modified. For example, certain port indicators may be changed from active to inactive to allow multiple original logical port groups to be represented by a single compressed logical port group. This compression process may result in the subset of compressed logical port groups that correspond to the group clusters 400.

Entries may be added in the hardware multi-path routing table 202 corresponding to the subset of compressed logical port groups. Each entry in the hardware multi-path routing table 202 may represent one of the group clusters 400, containing the compressed information for multiple original logical port groups.

The input routes may then be mapped to the entries in the hardware multi-path routing table. This mapping may allow the network switch to use the compressed routing information stored in the hardware multi-path routing table for packet forwarding decisions, while maintaining the relationships between input routes and their associated logical port groups.

In some cases, the clustering arrangement may allow multiple input routing table entries to be clustered and compressed into a smaller number of hardware table entries. This compression may enable the routing functionality to be maintained while working within the memory constraints of the hardware multi-path routing table.

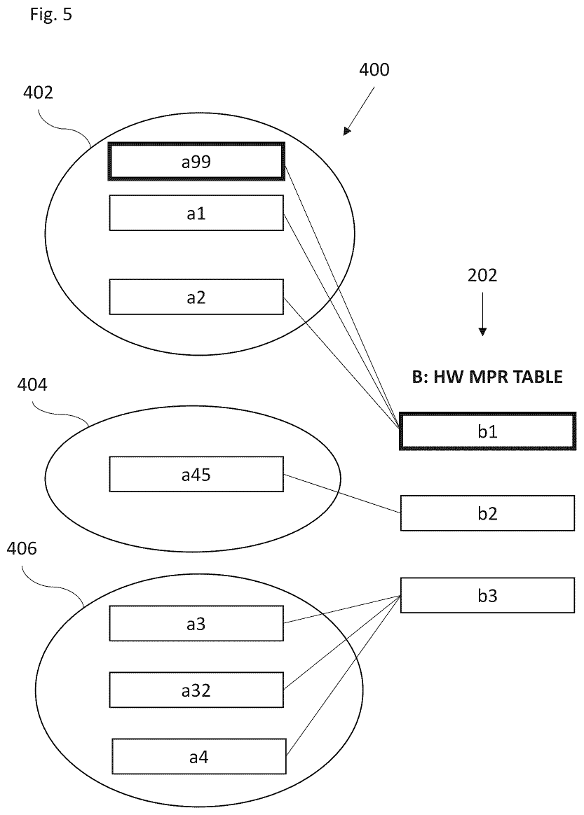

Reference is now made to FIG. 5, which is a diagram illustrating a system for adding entries to group clusters 400 in hardware multi-path routing table 202. When a new input route is received, the system may select the new input route for clustering.

The system may analyze options for handling the new input route. A first option may be to add the new input route to an existing group cluster. For example, as shown in FIG. 5, a new entry group a99 may be added to the first group cluster 402, which already contains entries for groups a1 and a2.

A second option may be to merge existing group clusters to create space for a new group cluster. For instance, the first group cluster 402 containing entries for groups a1 and a2 may be merged with the second group cluster 404 containing entry for group a45. This merging may create space in the hardware multi-path routing table 202 for the new entry for group a99 to be added as a new group cluster.

The system may select one of these options based on a defined cost function. The cost function may account for various factors, such as the similarity between the new input route and existing group clusters, the current utilization of the hardware multi-path routing table 202, and the impact on overall routing performance.

In some cases, when adding a new entry to an existing group cluster, the system may need to modify the compressed logical port group representing that cluster in the hardware multi-path routing table 202. In the example of FIG. 5, entry b1 has been changed. This modification may involve changing some port indicators from active to inactive to accommodate the new entry while maintaining a common set of active ports for entries in the cluster.

When merging group clusters, the system may create a new compressed logical port group that represents the combined set of entries. This new compressed group may preserve the common active ports across original entries while potentially sacrificing some individual port activations to achieve the compression.

The system may continuously evaluate and adjust the clustering as new entries are added or existing entries are modified. This dynamic process may allow the hardware multi-path routing table 202 to maintain an optimized representation of the routing information within its capacity constraints.

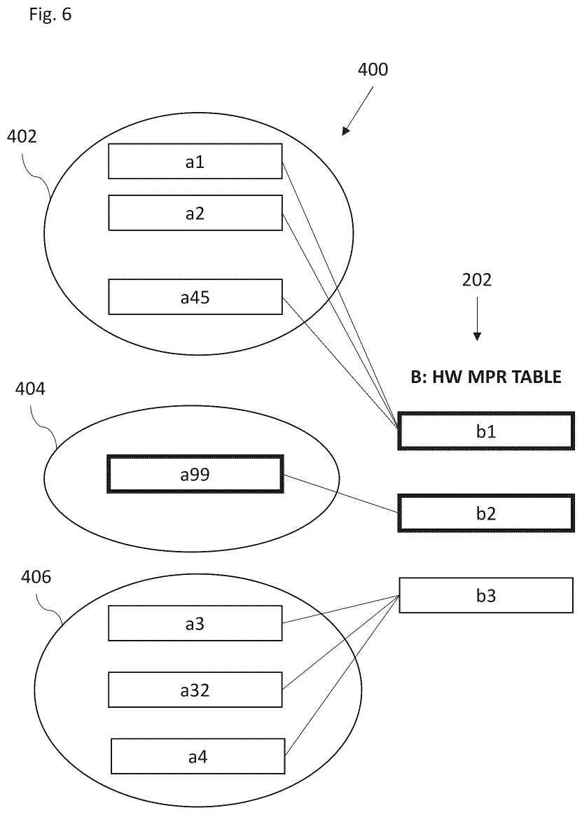

Reference is now made to FIG. 6, which is a diagram illustrating a system for merging clusters and adding a new cluster in a hardware multi-path routing system. In some cases, the system may merge group clusters to create space for new entries in the hardware multi-path routing table 202. For example, the entries of group cluster 402 (e.g., groups a1 and a2) and group cluster 404 (e.g., group a45) may be merged into a single group cluster, e.g., into group cluster 402, now including groups a1, a2, and a45. This merging process may allow a new entry to become available in the hardware multi-path routing table 202, enabling group cluster 404 to be used as a cluster for the new entry of group a99. When clusters are merged, the system may compress logical port groups by changing port indicators from active to inactive. In the example of FIG. 6 entries for groups b1 and b2 have been changed.

In some cases, the system may need to handle scenarios where ports are added or removed from the network switch. When a port is added or removed, the following actions may occur:
1. Update of Input Routing Table: The input routing table 300 may be modified to reflect the change in port configuration. For port addition, new entries may be created for routes that can now utilize the new port. For port removal, existing entries may be updated to remove references to the decommissioned port.
2. Recalculation of Logical Port Groups: The system may recalculate the logical port groups associated with affected routes. This process may involve updating the binary patterns that represent port activation states within the logical port groups.
3. Adjustment of Internal Data Structure: The internal data structure 302 may be updated to account for the changes in logical port groups. This may include modifying count information for affected port groups and potentially creating new unique port group entries or removing obsolete ones.
4. Re-evaluation of Group Clusters: The system may re-evaluate the group clusters 400 to determine if the port change affects the clustering arrangement. This may involve analyzing whether affected routes should be moved to different clusters or if new clusters should be formed.
5. Compression and Hardware Table Update: The compression algorithm may be reapplied to affected clusters to generate updated compressed logical port groups. The hardware multi-path routing table 202 may then be updated with these new compressed groups.
6. Remapping of Routes: Input routes affected by the port change may be remapped to potentially different entries in the hardware multi-path routing table 202 based on the updated clustering and compression results.
7. Performance Optimization: The system may perform additional optimizations to ensure that routing performance remains efficient after the port change. This may include re-evaluating the cost function for affected routes and potentially reorganizing clusters to minimize overall cost.

The cost function used for optimizing the clustering and compression process balances multiple factors to achieve efficient routing table compression while preserving sufficient routing information. The cost function may be defined as:

$$cost ( L , F , B ) = {\sum }_{g ∈ L} dist ( g , B [ F ( g ) ] )$$

Where:
L represents the input routing table,
F represents the mapping function from input routes to hardware multi-path routing groups,
B represents the hardware multi-path routing table, dist(g, B[F(g)]) is the distance between a group g to the cluster it is mapped to B[F(g)].

The distance between two port groups may be defined by a distance function dist(a,b).

The distance function may be further defined as:

$$dist ( a , b ) = \frac{‖ a ⊕ b ‖}{‖ a ‖} \cdot {Count [ i ]}^{α} \cdot w [ i ] \cdot priority [ i ]$$

This cost function accounts for several key factors:
1. Hamming distance: The term ∥a⊕b∥ represents the Hamming distance between the original logical port group (a) and the compressed logical port group (b). This measures the number of differing port indicators between the two groups.
2. Count of routes: The Count[i] term accounts for the number of routes mapped to each logical port group. This ensures that groups with more routes are given higher importance in the optimization process.
3. Weights: The w[i] term allows for the incorporation of weights associated with the routes. This may be used to prioritize certain routes based on their importance or expected traffic volume.
4. Priorities: The priority[i] term accounts for the priorities of the routes. This allows for differentiation between high-priority and low-priority routes in the compression process.
5. Alpha parameter: The configurable alpha (α) parameter in the exponent of Count[i] allows for balancing between optimizing the total cost across routes (e.g., all or a subset of routes) and the maximum cost for any single route.

In some cases, when alpha is set to a lower value, the optimization process may focus more on minimizing the average cost across routes (e.g., all or a subset of routes). Conversely, when alpha is set to a higher value, the process may prioritize minimizing the maximum cost for any individual route.

The alpha parameter may be adjusted based on specific network requirements and performance goals. For example, in networks where consistent performance across routes is desired, a lower alpha value may be chosen. In networks where avoiding worst-case scenarios for any single route is paramount, a higher alpha value may be preferred.

The cost function may be used in various stages of the clustering and compression process, including:
1. When deciding whether to add a new route to an existing cluster or create a new cluster,
2. When evaluating potential cluster mergers, and
3. During periodic optimization attempts to improve overall clustering.

By considering multiple factors and allowing for configurable parameters, the cost function provides a flexible and comprehensive approach to optimizing the compression of routing tables while maintaining sufficient routing information and performance characteristics.

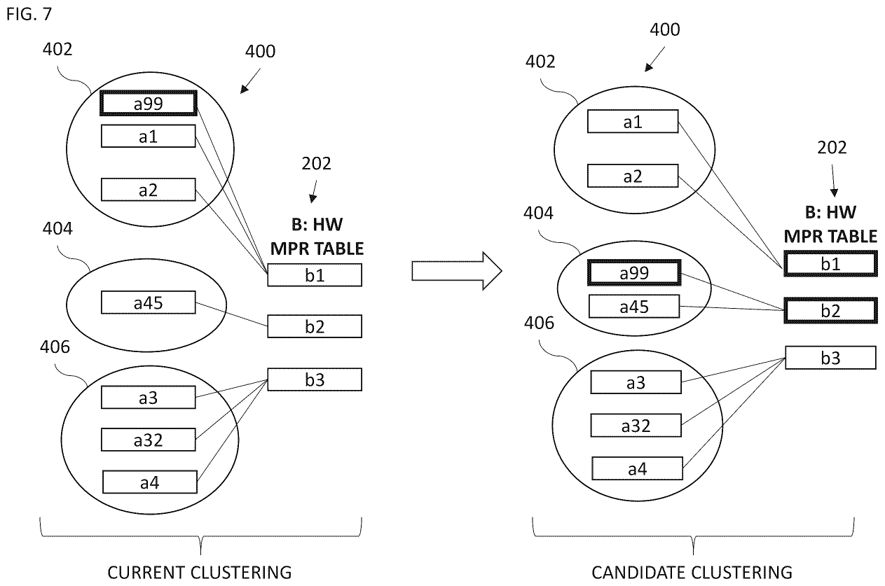

Reference is now made to FIG. 7, which is a diagram illustrating the process of improving clustering by moving groups between clusters in a hardware multi-path routing system.

The clustering algorithm may intermittently attempt to improve the clustering by selecting a logical port group with the highest distance from its mapped entry in the hardware multi-path routing table 202. In some cases, the algorithm may attempt to move the selected logical port group to a different group cluster to reduce the cost (e.g., total cost, maximum cost, etc.) across the routes (e.g., all or a subset of routes).

FIG. 7 illustrates an example where a group (e.g., a99) with the highest distance from its entry in the hardware multi-path routing table 202 is selected for potential movement. The selected group may be evaluated for relocation to a different group cluster, such as from group cluster 402 to group cluster 404 (as shown in FIG. 7), if such a move would reduce the overall cost for the routes (e.g., all or a subset of routes). In such a case, groups b1 and b2 is the hardware multi-path routing table 202 may need to be changed to reflect moving group a99 from group cluster 402 to group cluster 404.

In some cases, the algorithm may select a group that may not have the highest distance from its entry in the hardware multi-path routing table 202, but moving this group may still reduce the overall cost for the routes (e.g., all or a subset of routes). This approach allows the system to balance between optimizing for worst-case scenarios and improving average performance.

The clustering algorithm may recalculate distances and costs when ports are added or removed from logical port groups. This dynamic recalculation ensures that the clustering remains optimized as the network topology changes. For example, if a port is added to a logical port group, the algorithm may reevaluate the group's placement within the existing clusters and determine if moving the group to a different cluster would reduce the overall cost.

In some cases, the process of improving clustering may be performed intermittently or triggered by specific events, such as significant changes in network topology or traffic patterns. This ongoing optimization helps maintain efficient use of the limited capacity in the hardware multi-path routing table 202 while preserving sufficient routing information.

The movement of groups between clusters, as illustrated in FIG. 7, may be performed in a way that minimizes disruption to ongoing network operations. The hardware multi-path routing table 202 may be updated incrementally as groups are moved, allowing for continuous packet forwarding based on the most current optimized clustering.

In some implementations, the algorithm may consider multiple candidate moves simultaneously, evaluating the potential cost reduction of various group movements before selecting the most beneficial change. This approach may help avoid local optima and achieve a more globally optimized clustering solution.

The process of improving clustering through group movement may also take into account factors such as route priorities and weights. Higher priority routes or those with greater weights may be given preference when considering potential moves, ensuring that the most relevant routing information is optimally represented in the compressed format of the hardware multi-path routing table 202.

In some cases, the routing table compression algorithm may operate in both online and offline modes. In the online mode, the algorithm may process updates to the routing table as the updates arrive, allowing for real-time adjustments to the compressed table. In the offline mode, the algorithm may optimize the full routing table, potentially achieving better compression ratios by considering the entire dataset at once.

In some cases, the compression algorithm may be applied to other types of network architectures beyond the leaf-spine topology. For example, the algorithm may be adapted for use in mesh networks.

In some embodiments, the compression algorithm may be implemented in software running on general-purpose processors rather than in dedicated hardware. This software implementation may allow for greater flexibility in deploying and updating the compression technique across a variety of network devices.

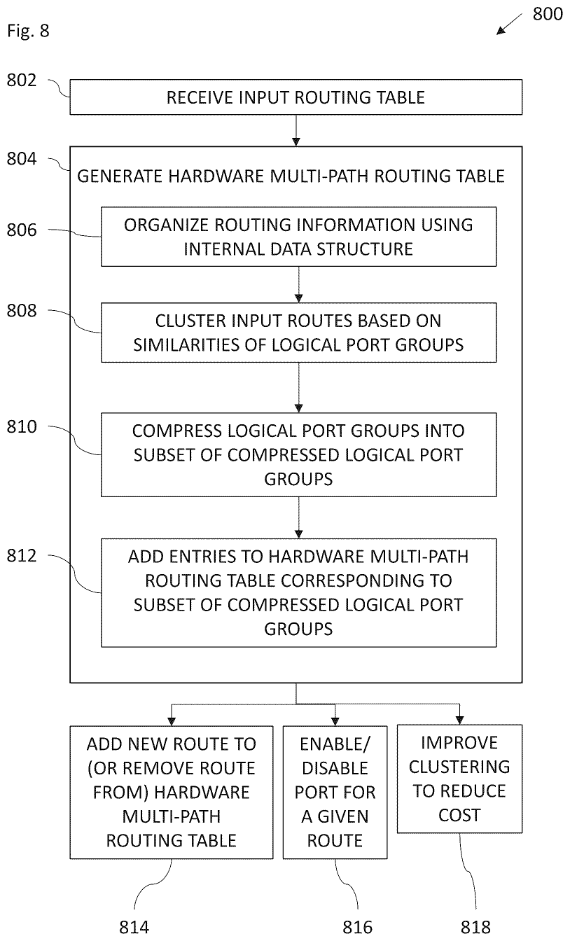

Reference is now made to FIG. 8, which is a flowchart illustrating a method 800 for compressing a routing table in a network switch. The method 800 processes routing information through multiple steps to achieve compression while maintaining routing functionality.

The method 800 begins at step 802 with receiving an input routing table. The input routing table may include input routes and associated logical port groups, such that each input route may be associated with a logical port group.

At step 804, the method 800 generates a hardware multi-path routing table 202. The hardware multi-path routing table 202 may have a capacity smaller than the input routing table. Step 804 may include sub-steps 806-812, described below.

At step 806, the method 800 organizes routing information from the input routing table using an internal data structure. In some cases, the internal data structure may aggregate and organize routing information from the input routing table. The internal data structure may include unique port groups and maintain count information for each unique port group.

At step 808, the method 800 clusters input routes into group clusters based on similarities between the associated logical port groups and minimizing the cost (e.g., total cost or maximum cost) associated with the clustering based on a cost function such as the cost function described above.

The method 800 continues to step 810, where logical port groups may be compressed into a subset of compressed logical port groups by modifying port indicators. The compression of logical port groups may involve changing one or more port indicators from active to inactive. This compression may allow multiple original logical port groups to be represented by a single compressed logical port group in the hardware multi-path routing table 202.

In some cases, the single compressed logical port group may maintain connectivity for the original logical port groups mapped to the single compressed logical port group. This may be achieved by preserving active port indicators that are common across the original logical port groups.

Here's an example of how two logical port groups can be compressed into one using strings of 0s and 1s:
Original logical port group 1: 11101110
Original logical port group 2: 11101100
Compressed logical port group: 11101100

In this example, the two original logical port groups are similar but not identical. The compression process preserves the common active ports (represented by 1s) that are shared between both groups. The resulting compressed logical port group maintains connectivity for both original groups by keeping the ports that are active in both groups (positions 1, 2, 3, 5, and 6) while setting the differing position (position 7) to inactive (0). This compression allows both original logical port groups to be represented by a single entry in the hardware multi-path routing table, potentially reducing memory usage while maintaining essential routing paths.

At step 812, the method 800 adds entries to the hardware multi-path routing table 202 corresponding to the subset of compressed logical port groups. The method 800 may then map the input routes to the entries in the hardware multi-path routing table 202.

The method 800 may then branch into three possible operations. In a first branch, step 814 involves adding a new route to, or removing a route from, the hardware multi-path routing table 202. In a second branch, step 816 involves enabling or disabling a port for a given route. In a third branch, step 818 involves improving clustering to reduce cost. The method 800 may intermittently attempt to improve the clustering by selecting one of the logical port groups with a highest distance from ones of the entries in the hardware multi-path routing table 202 mapped to the selected logical port group. The method 800 may then attempt to move the selected logical port group to a different one of the group clusters to reduce a cost (e.g., total or maximum cost, etc.) across the routes (e.g., all or a subset of routes).

In some implementations, the clustering algorithm may run in both online mode, processing updates as they arrive, and offline mode, optimizing the full table. This flexibility may allow the method 800 to adapt to different operational requirements. The clustering algorithm may be triggered to run in the offline mode when the switch is idle and/or intermittently, for example.

The method 800 may be applied to various network topologies. In some cases, the method 800 may be applied to a leaf-spine network topology. The method 800 may account for remote link failures in the network when updating port groups, ensuring that the compressed routing table remains effective even in the face of network changes.

In some implementations, the method 800 may initialize the hardware multi-path routing table 202 to be empty or to all ones, depending on the specific requirements of the network switch.

By following these steps, the method 800 may effectively compress a routing table while minimizing the cost of compression and maintaining the ability to handle dynamic updates to the network configuration.

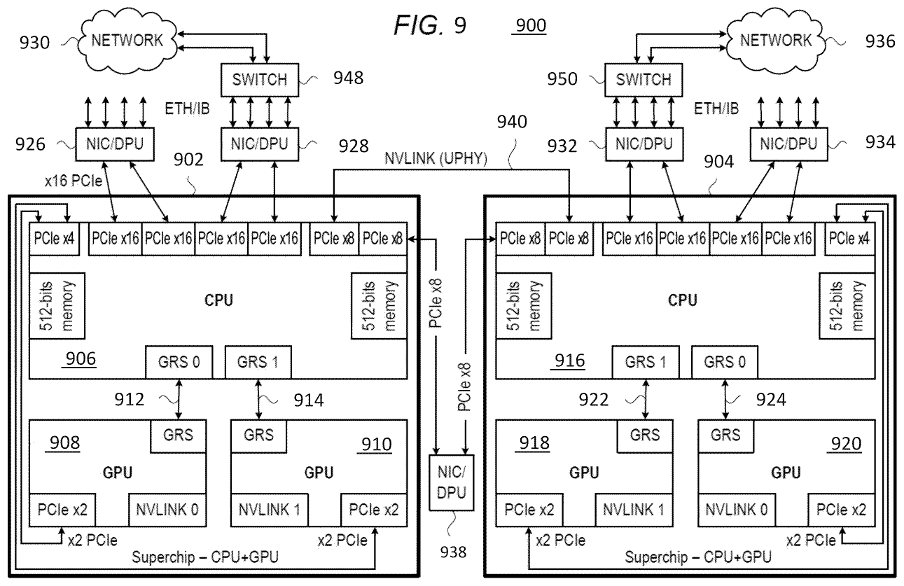

Reference is now made to FIG. 9, which is a block diagram that schematically illustrates a computing system 900, e.g., a data center or a High-Performance Computing (HPC) cluster, in accordance with an embodiment of the present disclosure.

System 900 comprises a plurality of subsystems, e.g., multiple processing devices coupled to each other, multiple network devices, and multiple networks, according to at least one embodiment. Computing system 900 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 900 and to one or more external networks 930, 936. In the present example, system 900 comprises a packet switch 948 that connects NIC/DPU 928 to network 930, and a packet switch 950 that connects NIC/DPU 932 to network 936.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 900 can include one or more CPUs and one or more GPUs.

FIG. 9 also demonstrates an example architecture of a multi-GPU architecture. As illustrated in the figure, computing system 900 includes a processing device 902 with a multi-GPU architecture. In particular, processing device 902 may be a system-on-chip and includes multiple subsystems such as a CPU 906, a GPU 908, and a GPU 910. CPU 906 can be coupled to GPU 908 via a die-to-die (D2D) or chip-to-chip (C2C) interconnect 912, such as a Ground-Referenced Signaling interconnect (GRS interconnect). CPU 906 can be coupled to GPU 910 via a D2D or C2C interconnect 914. CPU 906 can also couple to GPU 908 and GPU 910 via PCIe interconnects.

CPU 906 can be coupled to one or more NICs or DPUs, which are coupled to one or more networks. For example, as illustrated in FIG. 9, CPU 906 is coupled to a first NIC/DPU 926, which is coupled to a network 930. CPU 906 is also coupled to a second NIC/DPU 928, which is coupled to network 930 via switch 948. NIC/DPU 926 and NIC/DPU 928 can be coupled to network 930 over Ethernet (ETH), NVLINK or InfiniBand (IB) connections, for example.

Computing system 900 also includes a processing device 904 with a multi-GPU architecture. In particular, processing device 904 includes multiple subsystems including a CPU 916, a GPU 918, and a GPU 920. CPU 916 can be coupled to GPU 918 via a D2D or C2C interconnect 922. CPU 916 can be coupled to GPU 920 via a D2D or C2C interconnect 924. CPU 916 can also couple to GPU 918 and GPU 920 via PCIe interconnects. CPU 916 can be coupled to one or more NICs or DPUs, which are coupled to one or more networks. For example, as illustrated in FIG. 9, CPU 916 is coupled to a first NIC/DPU 932, which is coupled to a network 936. CPU 916 is also coupled to a second NIC/DPU 934, which is coupled to network 936 via switch 950. NIC/DPU 932 and NIC/DPU 934 can be coupled to network 936 over Ethernet (ETH), NVLINK or InfiniBand (IB) connections.

In at least one embodiment, processing device 902 and processing device 904 can communicate with each other via a NIC/DPU 938, such as over PCIe interconnects. Processing device 902 and processing device 904 can also communicate with each other over a high-bandwidth communication interconnect 940, such as an NVLink interconnect or other high-speed interconnects. The packet switches in FIG. 9 may comprise, for example, Nvidia Quantum-2 switches. The NICs/DPUs in the figure may comprise, for example, Nvidia Bluefield DPUs.

The network switch may include any of the following: ports where network cables connect; switching fabric that manages data transfer between ports; a MAC address table that stores device addresses and port information; a forwarding engine that directs data packets to the correct ports; buffer memory that temporarily holds data to manage traffic; a management processor that handles configuration and monitoring in managed switches; a power supply that provides electrical power; a cooling system that keeps the switch from overheating; firmware that controls the switch; LED Indicators that show status and activity; and networking modules (in modular switches) that allow for additional ports or features.

The quantities, numbers, and arrangements of the various elements described herein are provided by way of example and are not intended to be limiting. In various embodiments, the system may include any suitable number of processing devices, network switches, NICs, DPUs, GPUs, CPUs, interconnects, networks, ports, buffers, or other components as may be appropriate for a particular implementation. The specific quantities mentioned in the examples above may be scaled up or down depending on the requirements of the system, performance considerations, cost constraints, or other design factors. Additionally, the ratios and relationships between different components may be adjusted to optimize system performance for specific use cases or applications.

In practice, some or all of these functions may be combined in a single physical component or, alternatively, implemented using multiple physical components. These physical components may comprise hard-wired or programmable devices, or a combination of the two. In some embodiments, at least some of the functions of the processing circuitry may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The various elements described herein as performing particular tasks or steps may be configured to, adapted to, operative to, designed to, programmed to, or otherwise arranged to perform such tasks or steps. In some embodiments, these elements may include hardware components, software modules, firmware, or any combination thereof that enable the performance of the described functionality. The elements may be implemented using processing circuitry, dedicated hardware, programmable logic, or other suitable technologies that allow for the execution of the specified operations. Additionally, these elements may be selectively activated, controlled, or coordinated to perform their respective functions as part of the overall system operation.

The flowchart and block diagrams in the figures illustrate the architecture, functionality, and operation of possible implementations of systems, methods and computer program products according to various examples of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various examples of the present disclosure have been presented for purposes of illustration, but are not intended to be exhaustive or limited to the examples disclosed. Many modifications and variations will be apparent to those of ordinary skill in the art without departing from the scope and spirit of the described examples.

As used herein, the singular form “a”, “an” and “the” include plural references unless the context clearly dictates otherwise.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A network switch, comprising:
a memory to store an input routing table including input routes and associated logical port groups, such that each input route is associated with a logical port group; and
processing circuitry to:
generate a hardware multi-path routing table having a capacity smaller than the input routing table;
cluster the input routes into group clusters based on similarities between the associated logical port groups;
compress the logical port groups into a subset of compressed logical port groups by modifying port indicators, the subset of compressed logical port groups corresponding to the group clusters;
add entries in the hardware multi-path routing table corresponding to the subset of compressed logical port groups; and
map the input routes to the entries in the hardware multi-path routing table.

2. The network switch according to claim 1, wherein the processing circuitry is to generate an internal data structure to aggregate and organize routing information from the input routing table, wherein the internal data structure includes unique port groups and maintains count information for each unique port group.

3. The network switch according to claim 1, wherein the processing circuitry is to cluster the input routes by:
selecting a new input route;
analyzing options to add the new input route to an existing group cluster or to merge two existing group clusters to create space in the hardware multi-path routing table for a new group cluster, which includes the new input route; and
selecting one of the options that results in a lower cost based on a defined cost function.

4. The network switch according to claim 3, wherein the cost function accounts for: a Hamming distance between original and compressed logical port groups; and a count of the routes mapped to each logical port group.

5. The network switch according to claim 4, wherein the cost function accounts for: weights associated with the routes; and priorities of the routes.

6. The network switch according to claim 4, wherein the processing circuitry is to configure a parameter to balance between optimizing a total cost across the routes and optimizing a maximum cost for any single one of the routes.

7. The network switch according to claim 1, wherein the processing circuitry is to intermittently attempt to improve the clustering by:
selecting one of the logical port groups; and
attempting to move the selected logical port group to a different one of the group clusters to reduce a cost across the routes.

8. The network switch according to claim 1, wherein the processing circuitry is to compress the logical port groups by changing one or more port indicators from active to inactive to allow multiple original logical port groups to be represented by a single compressed logical port group in the hardware multi-path routing table.

9. The network switch according to claim 8, wherein the single compressed logical port group maintains connectivity for original logical port groups mapped to the single compressed logical port group by preserving active port indicators that are common across the original logical port groups.

10. The network switch according to claim 1, further comprising:
a plurality of network ports to receive and transmit data packets; and
a packet forwarding engine to forward the received data packets based on the hardware multi-path routing table.

11. The network switch according to claim 10, wherein the packet forwarding engine is to:
extract a destination address from a received data packet;
look up the destination address in the hardware multi-path routing table to determine an egress port; and
forward the data packet through the determined egress port.

12. A method for compressing a routing table in a network switch, comprising:
receiving an input routing table including input routes and associated logical port groups, such that each input route is associated with a logical port group;
generating a hardware multi-path routing table having a capacity smaller than the input routing table;
clustering the input routes into group clusters based on similarities between the associated logical port groups;
compressing the logical port groups into a subset of compressed logical port groups by modifying port indicators, the subset of compressed logical port groups corresponding to the group clusters;
adding entries in the hardware multi-path routing table corresponding to the subset of compressed logical port groups; and
mapping the input routes to the entries in the hardware multi-path routing table.

13. The method according to claim 12, further comprising generating an internal data structure to aggregate and organize routing information from the input routing table, wherein the internal data structure includes unique port groups and maintains count information for each unique port group.

14. The method according to claim 12, wherein clustering the input routes comprises:
selecting a new input route;
analyzing options to add the new input route to an existing group cluster or to merge two existing group clusters to create space in the hardware multi-path routing table for a new group cluster, which includes the new input route; and
selecting one of the options that results in a lower cost based on a defined cost function.

15. The method according to claim 14, wherein the cost function accounts for: a Hamming distance between original and compressed logical port groups; and a count of the routes mapped to each logical port group.

16. The method according to claim 15, wherein the cost function accounts for: weights associated with the routes; and priorities of the routes.

17. The method according to claim 15, further comprising configuring a parameter to balance between optimizing a total cost across the routes and optimizing a maximum cost for any single one of the routes.

18. The method according to claim 12, further comprising intermittently attempting to improve the clustering by:
selecting one of the logical port groups; and
attempting to move the selected logical port group to a different one of the group clusters to reduce a cost across the routes.

19. The method according to claim 12, wherein compressing the logical port groups comprises changing one or more port indicators from active to inactive to allow multiple original logical port groups to be represented by a single compressed logical port group in the hardware multi-path routing table.

20. The method according to claim 19, wherein the single compressed logical port group maintains connectivity for original logical port groups mapped to the single compressed logical port group by preserving active port indicators that are common across the original logical port groups.
